(19) United States
(12) Patent Application Publication
(10) Pub. No.: US 2026/0245787 A1
(43) Pub. Date: Aug. 20, 2026

(54) COIL ACTUATOR WITH ASYMMETRICAL MATERIAL COIL STRIPS

(71) Applicant: Toyota Motor Engineering & Manufacturing North America, Inc., Plano, TX (US)

(72) Inventors: Gurmeet Singh, Ann Arbor, MI (US); Yuyang Song, Ann Arbor, MI (US); Umesh N. Gandhi, Farmington Hills, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/057,125

(22) Filed: Feb. 19, 2025

(51) Int. Cl. H01F 27/28; H01F 7/08; H01F 41/04

(52) U.S. Cl. CPC H01F 27/2847; H01F 7/081; H01F 41/04

(57) ABSTRACT

Systems, methods, and other embodiments described herein relate to a coiled actuator with rotational and translational actuation. In one embodiment, an actuation device includes a first coil strip of a first material. The actuation device also includes a second coil strip of a second material. The second coil strip is joined to and asymmetrically disposed on an exterior surface of the first coil strip. A coefficient of thermal expansion of the second material is different than a coefficient of thermal expansion of the first material.

### TECHNICAL FIELD

The subject matter described herein relates, in general, to actuators and, more particularly, to a coiled actuation device having an asymmetrical cross-section and being formed of multiple strips of material, each material having different coefficients of thermal expansion.

### BACKGROUND

An actuator is a mechanical device that achieves physical movement. Specifically, an actuator converts input energy into mechanical force. The input energy may be of various types, including electrical, air, or hydraulic. The resultant mechanical force may move components within a system. For example, opposite ends of a linear actuator may be affixed to different components within a product, which components are to move relative to one another (i.e., periodically towards each other and away from each other). The actuator, responsive to the application of an activation input (e.g., electrical, air, or hydraulic energy), may move the respective components to achieve some objective of the system in which the actuator and components are disposed.

The types of devices in which actuators may be used vary as much as the physical movement produced by the various actuators. That is, actuators may achieve axial movement in any of three directions (e.g., x-, y, and z-directions), rotational movement about any of three axes (e.g., rotation about an x, y, or z-axis), bending motions, and complex combinations of any of the above-referenced motions. Various types of actuators may be found in robotic devices, medical devices, automotive systems, and others.

### SUMMARY

In one embodiment, example systems and methods relate to an actuation device that exhibits axial linear deflection and axial twisting.

In one embodiment, an actuation device is disclosed. The actuation device includes a first coil strip of a first material and a second coil strip of a second material. The second coil strip is joined to and asymmetrically disposed on an exterior surface of the first coil strip. A coefficient of thermal expansion of the second material is different than a coefficient of thermal expansion of the first material.

An actuation system is also disclosed. The actuation system includes an actuation device that includes a first coil strip of a first material and a second coil strip of a second material. The second coil strip is joined to and asymmetrically disposed on an exterior surface of the first coil strip. A coefficient of thermal expansion of the second material is different than a coefficient of thermal expansion of the first material. The actuation system also includes a power source to apply a shape-changing voltage across the actuation device.

In one embodiment, a method for forming a coil actuator with asymmetrical material coil strips is disclosed. The method includes forming a first material into a first coil strip and forming a second material into a second coil strip. A coefficient of thermal expansion of the second material is different than a coefficient of thermal expansion of the first material. The method also includes attaching the second coil strip to the first coil strip asymmetrically on an exterior surface of the first coil strip.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A-1C illustrate one embodiment of an actuation system with an actuation device that axially contracts and axially coils responsive to an activation input, according to an embodiment of the principles described herein.

FIGS. 2A-2C illustrate one embodiment of an actuation system with an actuation device that axially lengthens and axially uncoils responsive to an activation input, according to an embodiment of the principles described herein.

FIGS. 3A-3C illustrate one embodiment of an actuation system with an actuation device that axially contracts and axially uncoils responsive to an activation input, according to an embodiment of the principles described herein.

FIGS. 4A-4C illustrate one embodiment of an actuation system with an actuation device that axially lengths and axially coils responsive to an activation input, according to an embodiment of the principles described herein.

FIGS. 5A-5D illustrate embodiments of an actuation system with an actuation device with a circular cross-sectional shape, according to embodiments of the principles described herein.

FIG. 6 illustrates a flowchart for one embodiment of a method that is associated with forming a coil actuator with asymmetric material coil strips.

### DETAILED DESCRIPTION

Systems, methods, and other embodiments associated with converting an electrical input into mechanical energy are disclosed herein. As previously described, actuators may be found in various devices and may convert input energy into mechanical energy. Example devices that may include actuators include robotic devices, medical devices, and automotive systems, to name a few. Actuators may be found in countless other devices as well.

The device into which the actuator is to be used may dictate the type of actuator and operating parameters of a desired actuator. For example, to lift heavy loads, such as in an automotive application, a hydraulic or pneumatic actuator may be desired, which hydraulic actuators may have less movement precision than an electrically-triggered actuator. By comparison, a medical device may call for an actuator with a more precise movement, albeit a reduced load-carrying capacity. That is to say, the operating constraints of a device may define the characteristics of an actuator to be used, with different actuators being better suited for particular applications than others.

The actuator of the present specification provides relatively large lateral and torque forces per unit area and can provide rotational and linear actuation for several applications, including robotic devices, medical devices, and vehicle systems, among others. Note that while particular reference is made to particular industries where actuators may be used, the actuators described herein may be used in various applications.

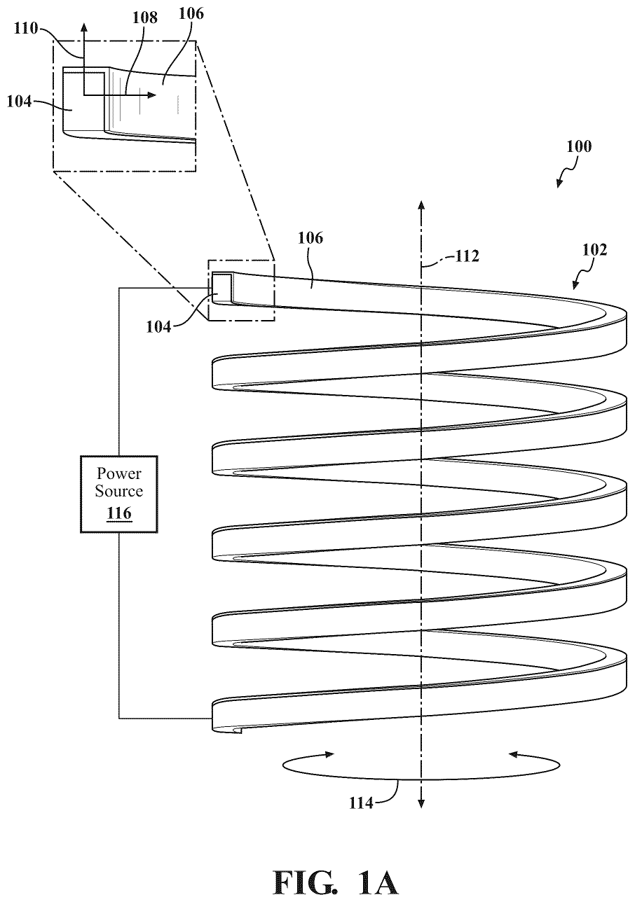

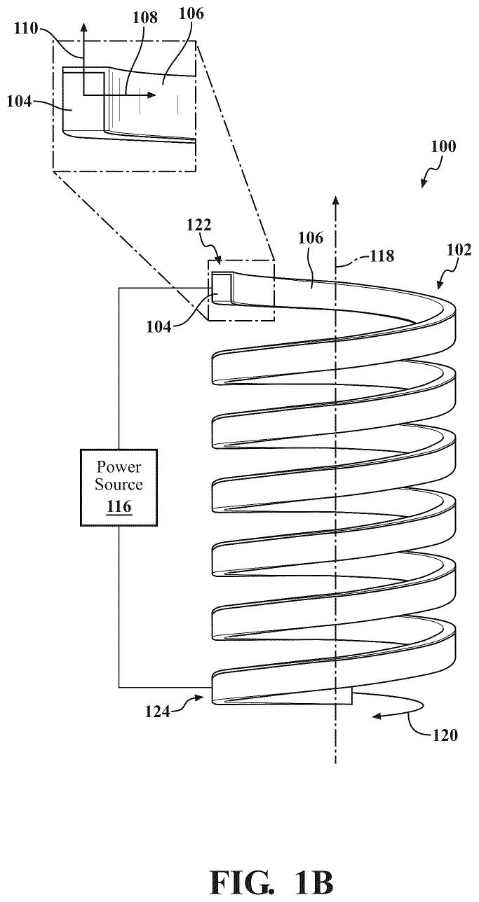

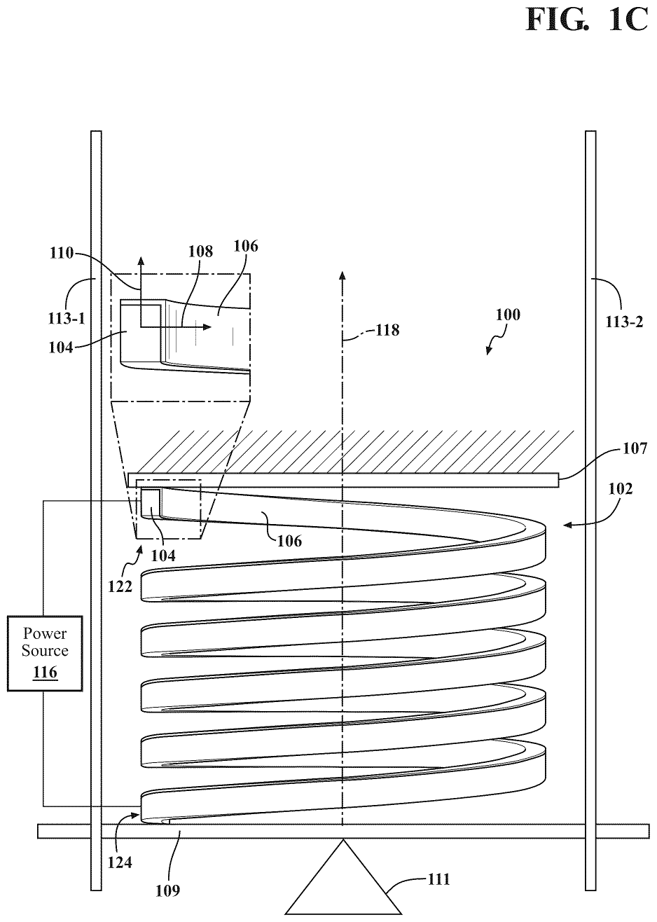

In general, the present specification describes an actuator with disparate materials formed into coil strips. Specifically, a first material has a particular cross-sectional shape and is formed into a helical coil strip such as a spring shape. A second material has a different cross-sectional shape, is formed into a coil strip, and is joined to the first material coil strip. The second material coil strip is asymmetrically disposed on the exterior surfaces of the first coil strip. For example, the first coil strip may have a rectangular cross-sectional shape and the second coil strip may have an L-shaped cross-sectional shape. The second coil strip may be disposed on the first coil strip such that the legs of the L-shaped second coil strip are disposed on adjacent surfaces of the first coil strip. As such, the actuation device has an asymmetric cross-section, meaning that the actuation device does not have cross-sectional axes of symmetry along orthogonal axes, as depicted in FIGS. 1A-5D.

Each material has a different coefficient of thermal expansion (CTE). For example, the L-shaped second material may have a lower CTE than the first material that makes up the main body of the actuator. Accordingly, the different materials react differently to an activation input. For example, the actuation device may be heated up via Joule heating. That is, an electrical current may be passed through the coil strips. This current may cause the temperature of both the first and second material strips to rise. Given that each material has a different CTE, each material reacts differently to the applied heat. Specifically, a material with a lower CTE may expand to a lesser degree than one with a higher CTE. Given the above example, the L-shaped second coil strip may expand to a lesser degree than the main body first coil strip because the second material has a lower CTE than the first material. Given the coil shape of the actuation device, the resulting mechanical movement from the activation input and difference in CTE is axial deformation (i.e., axial contraction or axial extension) and axial twisting (i.e., axial coiling or axial uncoiling).

The surfaces of the L-shaped second material and the rectangular main body material that are bonded together (i.e., which surfaces of the rectangular main body are layered with legs of the second material strip), defines the specific actuation of the actuation device, which actuation may include a combination of 1) one of axial contraction or expansion and 2) one of axial coiling and uncoiling.

That is, the asymmetry of the cross-section of the actuation device results in coupled expansion/contraction along two different orthogonal axes (e.g., an x-axis and a y-axis), with the expansion/contraction along each axis being based upon which opposite surface of the actuation device includes the L-shaped second material. In one particular example, the axial stroke (i.e., the amount of axial contraction/extension) can be enhanced by rotationally fixing one end of the coil actuator. Note that while particular reference is made to an example of an actuator with a rectangular cross-section, the actuation device may have other cross-sections, such as a circular cross-section.

In this way, the disclosed systems, methods, and other embodiments provide a coil actuator with linear and rotational actuation with a large stroke and torsional deflection. This is specifically provided by adhering/bonding disparate CTE materials together to have an asymmetric cross-sectional arrangement.

Turning now to the figures, FIGS. 1A-1C illustrate one embodiment of an actuation system 100 that axially contracts and axially coils responsive to an activation input, according to an embodiment of the principles described herein. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

As described above, the actuation device 102 may exhibit linear movement along an axial or longitudinal direction as indicated by the arrow 112 and rotational movement about the longitudinal axis as indicated by the arrow 114. As depicted in FIGS. 1A-4C, the direction of linear deflection and axial twisting is dependent upon which surfaces of the first coil strip 104 are covered by the second coil strip 106.

As described above, the actuation device 102 includes a first coil strip 104 of a first material and a second coil strip 106 of a second material. The first coil strip 104 and the second coil strip 106 may be formed of different materials, specifically materials with different coefficients of thermal expansion. Specifically, the second coil strip 106 may be formed of a material (i.e., a second material) that has a lower CTE than the material that forms the first coil strip 104 (i.e., the first material). In a specific example, example CTE ranges for the first material may be between 40×10⁻⁶ K⁻¹ and 100×10⁻⁶ K⁻¹, and example CTE ranges for the second material may be between 1×10⁻⁶ K⁻¹ and 20×10⁻⁶ K⁻¹. Accordingly, a difference in CTE of the two materials may be between 20×10⁻⁶ K⁻¹ and 100×10⁻⁶ K⁻1. While particular reference is made to particular CTE values and differences between CTEs of the different materials, materials with other CTE values and ranges may be used based on the application/system into which the actuation device 102 is installed.

The materials that make up the first and second coil strips may vary. For example, the first material and the second material may be metallic. As a specific example, the first material that forms the first coil strip 104 may be aluminum, which has a CTE of between 21×10⁻⁶ K⁻¹ and 24×10⁻⁶ K⁻¹, and the second coil strip 106 may be formed of a second material, such as a nickel iron alloy which has a CTE of between 1.2×10⁻⁶ K⁻¹ and 10×10⁻⁶ K⁻¹. As another example, the first material may be a polymer material, such as epoxy, which has a CTE of between 40×10⁻⁶ K⁻¹ and 100×10⁻⁶ K⁻¹. In this example, the second material may be another metallic material, such as a nickel-iron alloy, which may have a CTE of between 1.2×10⁻⁶ K⁻¹ and 10×10⁻⁶ K⁻¹.

While particular reference is made to particular example materials, the first coil strip 104 and the second coil strip 106 may be formed of different materials. Example materials used for the first coil strip 104 include shape memory polymers, elastomers, and plastic materials, among others. The materials used for the second coil strip 106 may include aluminum, steel, copper, and other iron-nickel alloys, among others. In any case, the CTEs of the different materials should be different enough to exhibit the linear deflection/deformation and twisting movement triggered by the difference in CTEs. In an example, the amount of linear and torsional deflection may be based on the difference in CTE between the materials that make up the first coil strip 104 and the second coil strip 106, with a larger difference resulting in greater stroke and torsional deflection.

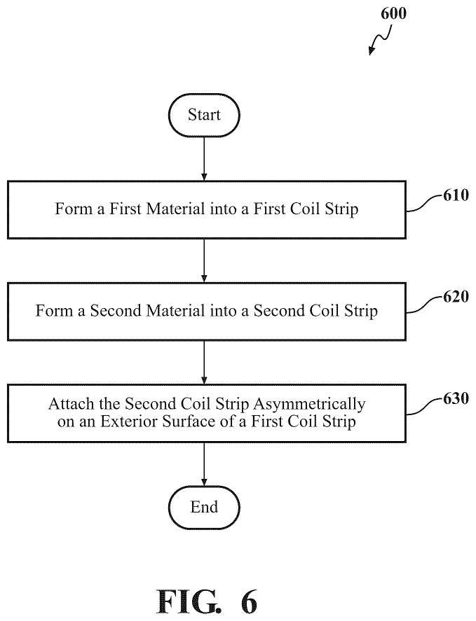

As depicted in FIGS. 1A-5D, the second coil strip 106 is joined to the first coil strip 104. As described below in FIG. 6, the method of joining the first coil strip 104 and the second coil strip 106 may vary and may be based on the materials. Example joining methods include chemical bonding and adhesion. In either case, this bonding/adhesion between the two strips facilitates the axial deflection and twisting.

As depicted in FIGS. 1A-5D, the second coil strip 106 is asymmetrically disposed on the exterior surface of the first coil strip 104. That is to say, the cross-section of the actuation device 102 has an asymmetric cross-section in two orthogonal directions. Specifically, the actuation device 102 is asymmetrical about the x-axis 108 of the cross-section, and the actuation device 102 is asymmetrical about the y-axis 110 of the cross-section. That is to say, the physical structure of the top portion of the actuation device 102 above an x-axis 108 differs from the physical structure of the bottom portion of the actuation device 102 below the x-axis 108. Similarly, the physical structure of an inside portion of the actuation device 102 (i.e., to the right of the y-axis 110) differs from that of an outside portion of the actuation device 102 (i.e., to the left of the y-axis 110).

This asymmetry about both orthogonal axes 108 and 110 facilitates the linear and torsional deformation. The characteristics of the asymmetry, that is the surfaces of the first coil strip 104 that are overlaid with the second coil strip 106, define the direction of axial deflection/deformation and axial twist as described below.

The actuation system 100 also includes a power source 116 to apply a shape-changing current across the actuation device 102. Each material has a coefficient of thermal expansion (CTE) property, which describes how the material changes based on a temperature change. The actuation device 102 leverages the disparate CTEs of the materials of the first coil strip 104 and the second coil strip 106 to generate the desired mechanical movement. The power source 116 provides the actuating energy, specifically via Joule heating. Joule heating is the process by which electrical current through a conductor produces heat. Accordingly, the power source 116 passes an electrical current through both the first coil strip 104 and the second coil strip 106 of the actuation device 102. This electrical current increases the temperature of both strips 104 and 106, with the different materials responding differently (e.g., changing material properties) to the temperature increase.

While FIGS. 1A-5D depict one particular type of heat source (i.e., a current-providing power source 116), different heat sources may be implemented. For example, the actuation device 102 could be exposed to temperature increase from a heat gun.

Returning to the actuation device 102, as described above, the actuation device 102 includes coil strips having asymmetrical cross-sectional areas. The second coil strip 106 is disposed on top of a portion of the exterior surface of the first coil strip 104, which covered portion results in an actuation device 102 with an asymmetrical cross-section. In one particular example, the first coil strip 102 has a quadrilateral cross-sectional shape with four right-angled corners. As depicted in FIGS. 1A-5D, the first coil strip 104 may have a rectangular cross-sectional shape. In another example, the first coil strip 104 may have a square cross-sectional shape. In this same example, the second coil strip 106 may have an L-shaped cross-sectional shape and may be disposed on two adjacent exterior surfaces of the quadrilateral cross-sectional shape of the first coil strip 104.

The direction of axial deflection (in the direction of the arrow 112) is based on which of the top or bottom surface of the first coil strip 104, the second coil strip 106 is disposed. The direction of axial twist (in the direction of the arrow 114) is based on which of an inside or outside surface of the first coil strip 104, a second leg of the second coil strip 106 is disposed. Specifically, as depicted in FIGS. 1A-1C, in a y-axis 110 direction, 1) the second material being disposed on a top surface of the first material and 2) the second material having a lower CTE than the first material, causes the actuation device 102 to contract in an axial direction as depicted by the arrow 118 in FIG. 1B. That is, in a bi-material actuation device 102, movement is generally towards the material with the lower CTE in a particular direction. As the lower CTE material (i.e., the second material) is on top of the higher CTE material (i.e., the first material), the movement of the actuation device 102 in the y-axis 110 direction is generally upwards in the frame of view of FIGS. 1A-1C.

By comparison, in an x-axis 108 direction, 1) the second material being disposed on an inside surface of the first material and 2) the second material having a lower CTE than the first material causes the actuation device 102 to tighten or coil further about a longitudinal axis as depicted by the arrow 120 in FIG. 1B. That is, in a bi-material actuation device 102, movement is generally towards the material with the lower CTE in a particular direction. As the lower CTE material (i.e., the second material) is on the inside of the higher CTE material (i.e., the first material), the rotation of the actuation device 102 about the y-axis 110 is generally inwards, i.e., a tighter coiling about the y-axis 110.

As described above, the degree of axial and torsional deflection may be based on the difference in CTE of the corresponding materials. Other factors may also determine the degree of axial and torsional deflection. Examples include the length of the coil strips (which may be between 50 to 100 cm, for example), the pitch of the coil, and the dimensions of the different coil strips. In an example, the first coil strip 104 may have a cross-sectional height of between a few millimeters to a few centimeters and a cross-sectional width of between a few millimeters to a few centimeters. In an example, the legs of the second coil strip 106 may have similar respective cross-sectional height and width dimensions. Another dimension that may affect the amount of axial and torsional deflection is the thickness of the second coil strip 106, which may be between one-fifth to one-tenth of the height of the first coil strip 104, for example. Yet another example of a dimension that may affect the amount of axial and torsional deflection is the length of an unstretched coil strip, which may have various lengths. Note that while particular reference is made to particular dimensions, the actuation device 102 may be implemented with different dimensions, with different dimensions selected based on desired deflection values (e.g., different axial and torsional deflections).

As such, the asymmetric dual material coil actuation device 102 may facilitate axial and torsional deflection/deformation. In some examples, the amount of axial deflection can be adjusted by preventing rotation of the actuation device 102. For example, as depicted in FIG. 1B, a first end 122 of the actuation device 102 may be rigidly attached to a reference surface. That is, the first end 122 may not move (either axially or torsionally) relative to the reference surface. The second end 124, by comparison, may be translationally and rotationally moveable relative to the first end 122. That is, the second end 124 may be a free end. Put yet another way, the second end may deflect in the direction indicated by the arrow 118 and may twist in the direction indicated by the arrow 120.

In an example depicted in FIG. 1C, the first end 122 may be rigidly attached to the reference surface 107 and, therefore, does not deflect in an axial or torsional direction relative to the reference surface 107. However, in this example, the second end 124 is linearly moveable but rotationally fixed relative to the first end 122. That is, the first end 122 and the second end 124 are in the same relative axial position even as the second end 124 may translate axially. For example, a transverse rod 109 may be attached to the second end 124. A weight 111 may be hung from the transverse rod 109. The weight 111, plus an interaction between the transverse rod 109 and a pair of linear guide rails 113-1 and 113-2, prevent the rotation of the second end 124 relative to the first end 122, but that allows the second end 124 to translate upwards as indicated by the arrow 118. The stroke, or translational distance, of the second end 124 may be greater when the second end 124 is prevented from twisting, as depicted in FIG. 1C.

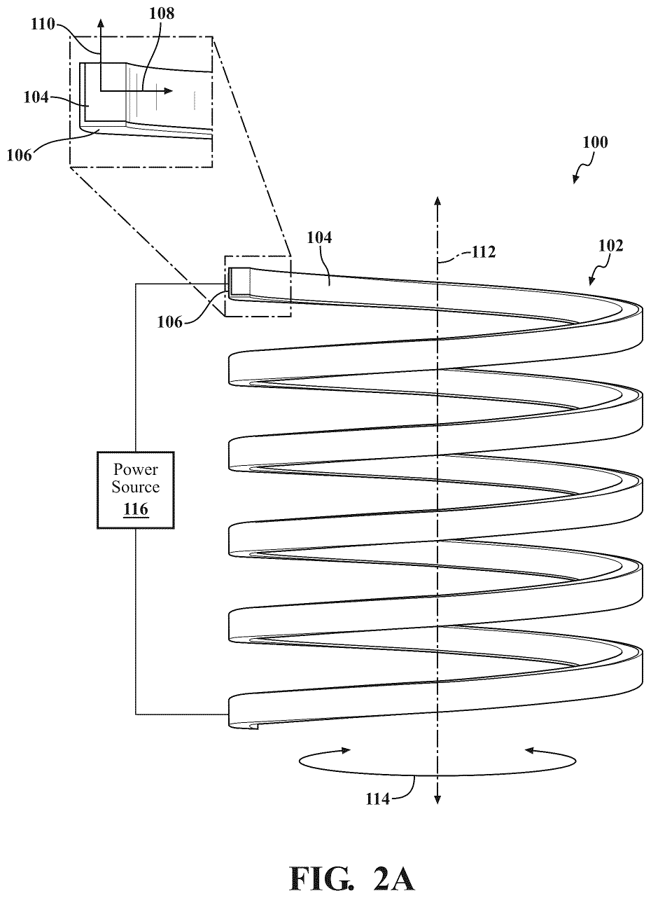

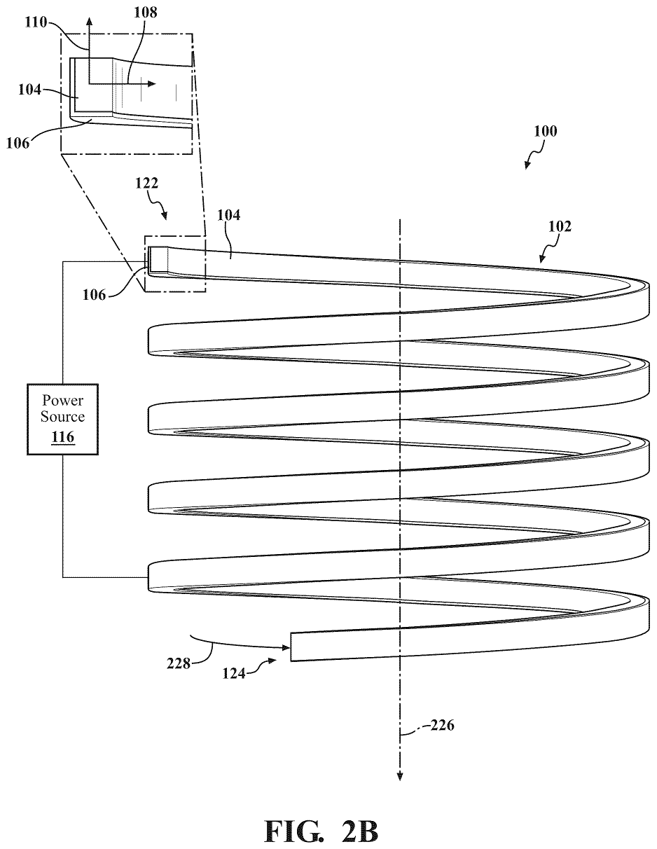

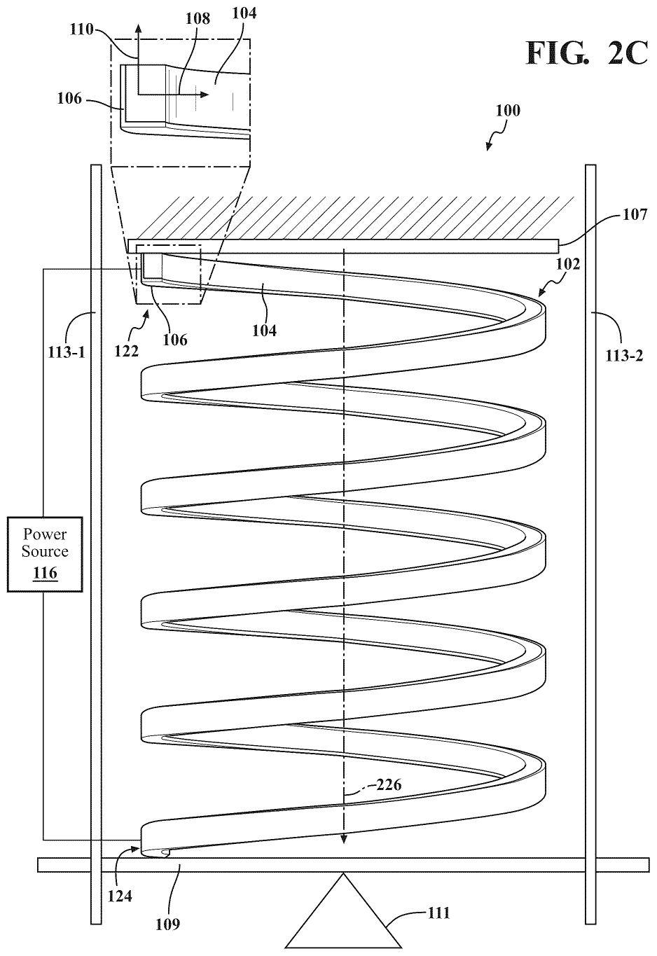

FIGS. 2A-2C illustrate one embodiment of an actuation device 102 that axially lengthens and axially uncoils responsive to an activation input, according to an embodiment of the principles described herein. As described above, the surfaces of the first coil strip 104 over which the surfaces of the second coil strip 106 are disposed define the actuation characteristics of the actuation device 102. In the example depicted in FIGS. 2A-2C, the first leg of the second coil strip 106 is disposed on the bottom surface of the first coil strip 104, and a second leg of the second coil strip 106 is disposed on the outside surface of the first coil strip 104. As with the example depicted in FIGS. 1A-1C, the actuation device 102 has an asymmetric cross-section in two orthogonal directions. Specifically, the actuation device 102 is asymmetrical about the x-axis 108 of the cross-section, and the actuation device 102 is asymmetrical about the y-axis 110 of the cross-section. That is to say, the physical structure of the top portion of the actuation device 102 above an x-axis 108 differs from the physical structure of the bottom portion of the actuation device 102 below the x-axis 108. Similarly, the physical structure of an inside portion of the actuation device 102 (i.e., to the right of the y-axis 110) differs from that of an outside portion of the actuation device 102 (i.e., to the left of the y-axis 110).

This asymmetry about both orthogonal axes 108 and 110 facilitates the linear and torsional deformation. The characteristics of the asymmetry, that is the surfaces of the first coil strip 104 that are overlaid with the second coil strip 106 define the direction of axial deflection/deformation as indicated by the arrow 112 and axial twist as indicated by the arrow 114.

Specifically, as depicted in FIGS. 2A-2C, in a y-axis 110 direction, 1) the second material being disposed on a bottom surface of the first material and 2) the second material having a lower CTE than the first material, causes the actuation device 102 to extend in an axial direction as depicted by the arrow 226 in FIG. 2B. That is, in a bi-material actuation device 102, movement is generally towards the material with the lower CTE in a particular direction. As the lower CTE material (i.e., the second material) is below the higher CTE material (i.e., the first material), the movement of the actuation device 102 in the y-axis 110 direction is generally downwards in the frame of view of FIGS. 2A-2C.

By comparison, in an x-axis 108 direction, 1) the second material being disposed on an outside surface of the first material and 2) the second material having a lower CTE than the first material causes the actuation device 102 to uncoil further about a longitudinal axis as depicted by the arrow 228 in FIG. 2B. That is, in a bi-material actuation device 102, movement is generally towards the material with the lower CTE in a particular direction. As the lower CTE material (i.e., the second material) is on the outside of the higher CTE material (i.e., the first material), the rotation of the actuation device 102 about the y-axis 110 is generally outwards, i.e., a looser coiling about the y-axis 110.

As described above, in some examples, the amount of linear deflection can be adjusted by preventing the rotation of the actuation device 102. For example, as depicted in FIG. 2B, a first end 122 of the actuation device 102 may be rigidly attached to a reference surface. That is, the first end 122 may not move (either axially or torsionally) relative to the reference surface. The second end 124, by comparison, may be translationally and rotationally moveable relative to the first end 122. That is, the second end 124 may be a free end. Put yet another way, the second end 124 may translate in the direction indicated by the arrow 226 and may twist in the direction indicated by the arrow 228.

In an example depicted in FIG. 2C, the first end 122 may be rigidly attached to the reference surface 107 and, therefore, does not deflect in an axial or torsional direction relative to the reference surface 107. However, in this example, the second end 124 is linearly moveable but rotationally fixed relative to the first end 122. That is, the first end 122 and the second end 124 are in the same relative axial position even as the second end 124 may translate axially. For example, a transverse rod 109 may be attached to the second end 124. A weight 111 may be hung from the transverse rod 109. The weight 111, plus an interaction between the transverse rod 109 and a pair of linear guide rails 113-1 and 113-2, prevent the rotation of the second end 124 relative to the first end 122, but that allows the second end 124 to translate downwards as indicated by the arrow 226. The stroke, or translational distance, of the second end 124 may be greater when the second end 124 is prevented from twisting, as depicted in FIG. 2C.

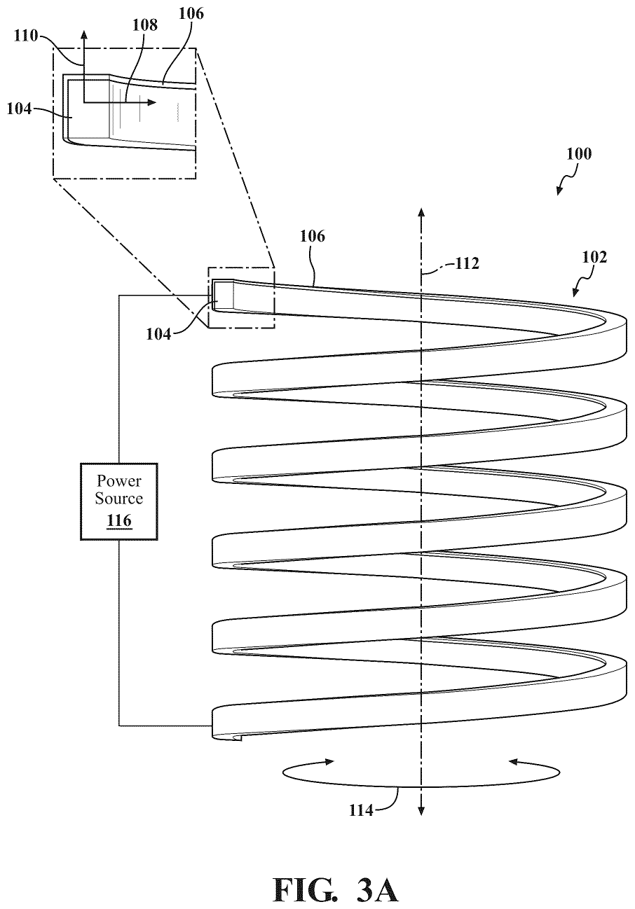

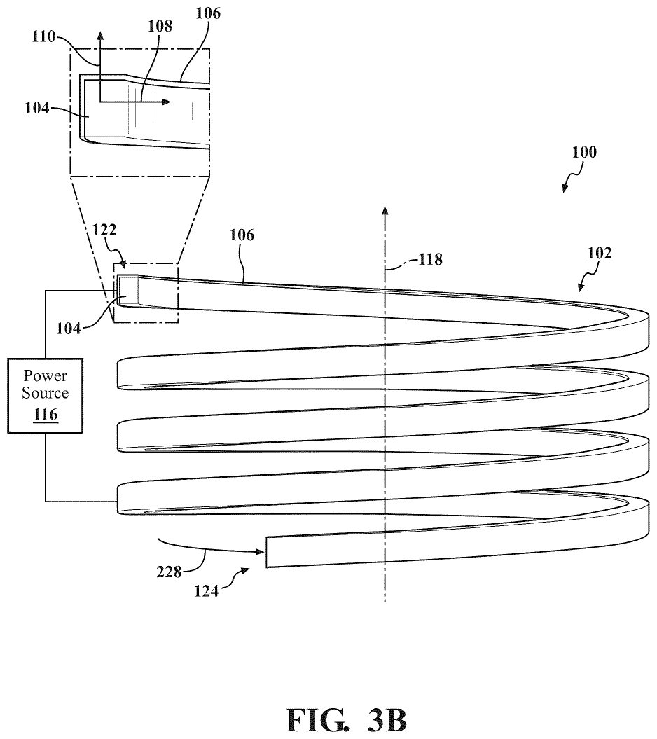

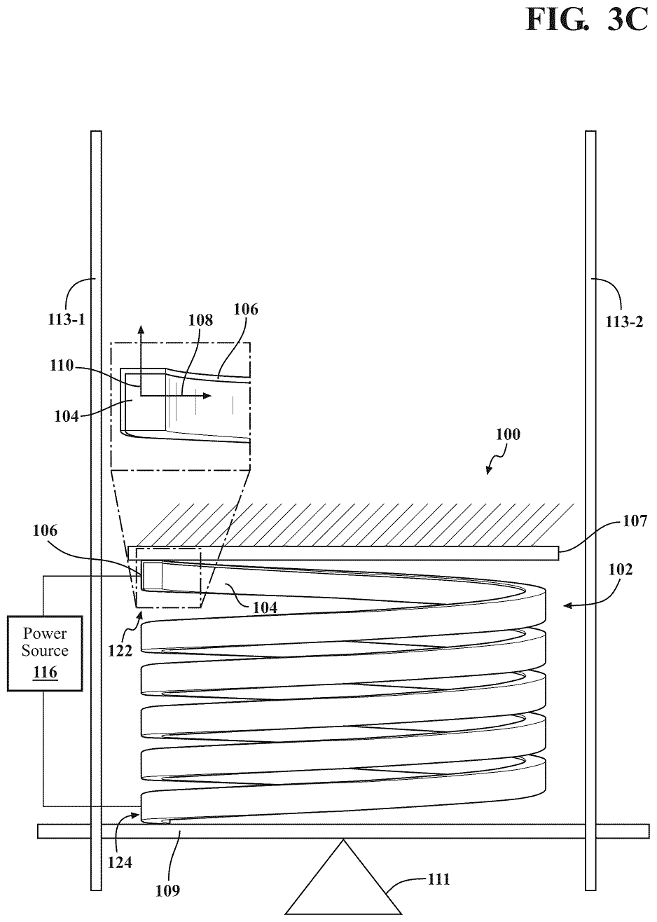

FIGS. 3A-3C illustrate one embodiment of an actuation device 102 that axially contracts and axially uncoils responsive to an activation input, according to an embodiment of the principles described herein. As described above, the surfaces of the first coil strip 104 over which the surfaces of the second coil strip 106 are disposed define the actuation characteristics of the actuation device 102. In the example depicted in FIGS. 3A-3C, the first leg of the second coil strip 106 is disposed on the top surface of the first coil strip 104, and a second leg of the second coil strip 106 is disposed on the outside surface of the first coil strip 104. As with the example depicted in FIGS. 1A-1C, the actuation device 102 has an asymmetric cross-section in two orthogonal directions. Specifically, the actuation device 102 is asymmetrical about the x-axis 108 of the cross-section, and the actuation device 102 is asymmetrical about the y-axis 110 of the cross-section. That is to say, the physical structure of the top portion of the actuation device 102 above an x-axis 108 differs from the physical structure of the bottom portion of the actuation device 102 below the x-axis 108. Similarly, the physical structure of an inside portion of the actuation device 102 (i.e., to the right of the y-axis 110) differs from the physical structure of an outside portion of the actuation device 102 (i.e., to the left of the y-axis 110).

This asymmetry about both orthogonal axes 108 and 110 facilitates the linear and torsional deformation. The characteristics of the asymmetry, that is the surfaces of the first coil strip 104 that are overlaid with the second coil strip 106 define the direction of axial deflection/deformation as indicated by the arrow 112 and axial twist as indicated by the arrow 114.

Specifically, as depicted in FIGS. 3A-3C, in a y-axis 110 direction, 1) the second material being disposed on a top surface of the first material and 2) the second material having a lower CTE than the first material, causes the actuation device 102 to contract in an axial direction as depicted by the arrow 118 in FIG. 3B. That is, in a bi-material actuation device 102, movement is generally towards the material with the lower CTE in a particular direction. As the lower CTE material (i.e., the second material) is above the higher CTE material (i.e., the first material), the movement of the actuation device 102 in the y-axis 110 direction is generally upwards in the frame of view of FIGS. 3A-3C.

By comparison, in an x-axis 108 direction, 1) the second material being disposed on an outside surface of the first material and 2) the second material having a lower CTE than the first material causes the actuation device 102 to uncoil further about a longitudinal axis as depicted by the arrow 228 in FIG. 3B. That is, in a bi-material actuation device 102, movement is generally towards the material with the lower CTE in a particular direction. As the lower CTE material (i.e., the second material) is on the outside of the higher CTE material (i.e., the first material), the rotation of the actuation device 102 about the y-axis 110 is generally outwards, i.e., a looser coiling about the y-axis 110.

As described above, in some examples, the amount of linear deflection can be adjusted by preventing the rotation of the actuation device 102. For example, as depicted in FIG. 3B, a first end 122 of the actuation device 102 may be rigidly attached to a reference surface. That is, the first end 122 may not move (either axially or torsionally) relative to the reference surface. The second end 124, by comparison, may be translationally and rotationally moveable relative to the first end 122. That is, the second end 124 may be a free end. Put yet another way, the second end 124 may translate in the direction indicated by the arrow 118 and may twist in the direction indicated by the arrow 228.

In an example depicted in FIG. 3C, the first end 122 may be rigidly attached to the reference surface 107 and, therefore, does not deflect in an axial or torsional direction relative to the reference surface 107. However, in this example, the second end 124 is linearly moveable but rotationally fixed relative to the first end 122. That is, the first end 122 and the second end 124 are in the same relative axial position even as the second end 124 may translate axially. For example, a transverse rod 109 may be attached to the second end 124. A weight 111 may be hung from the transverse rod 109. The weight 111, plus an interaction between the transverse rod 109 and a pair of linear guide rails 113-1 and 113-2, prevent the rotation of the second end 124 relative to the first end 122, but that allows the second end 124 to translate upwards as indicated by the arrow 118. The stroke, or translational distance, of the second end 124 may be greater when the second end 124 is prevented from twisting, as depicted in FIG. 3C.

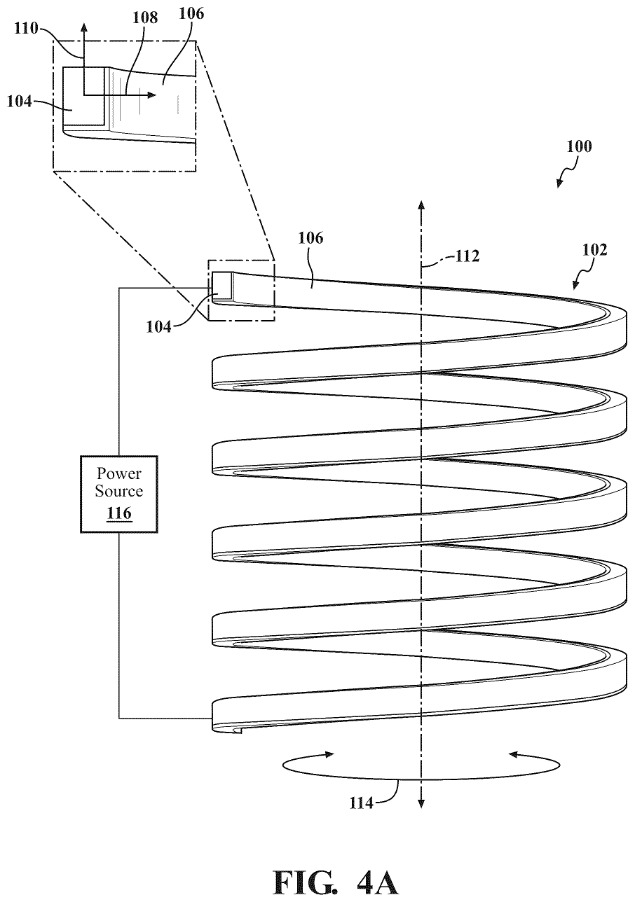

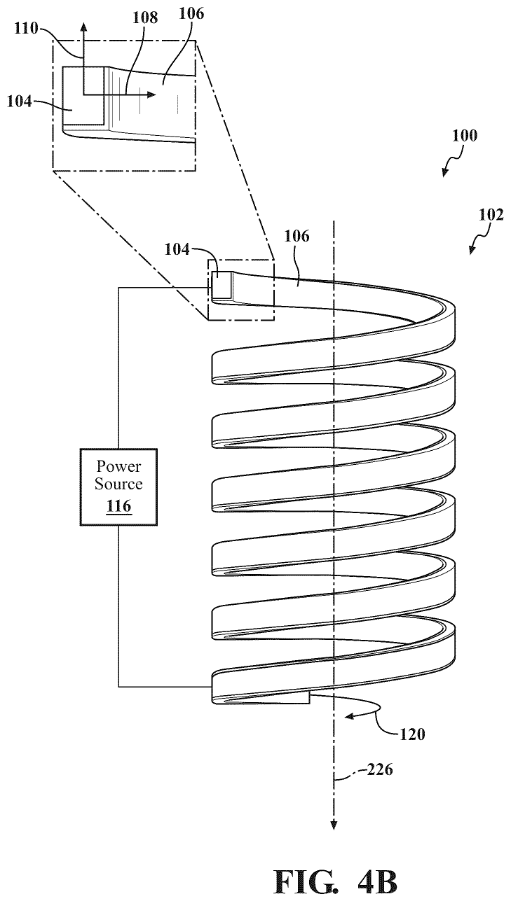

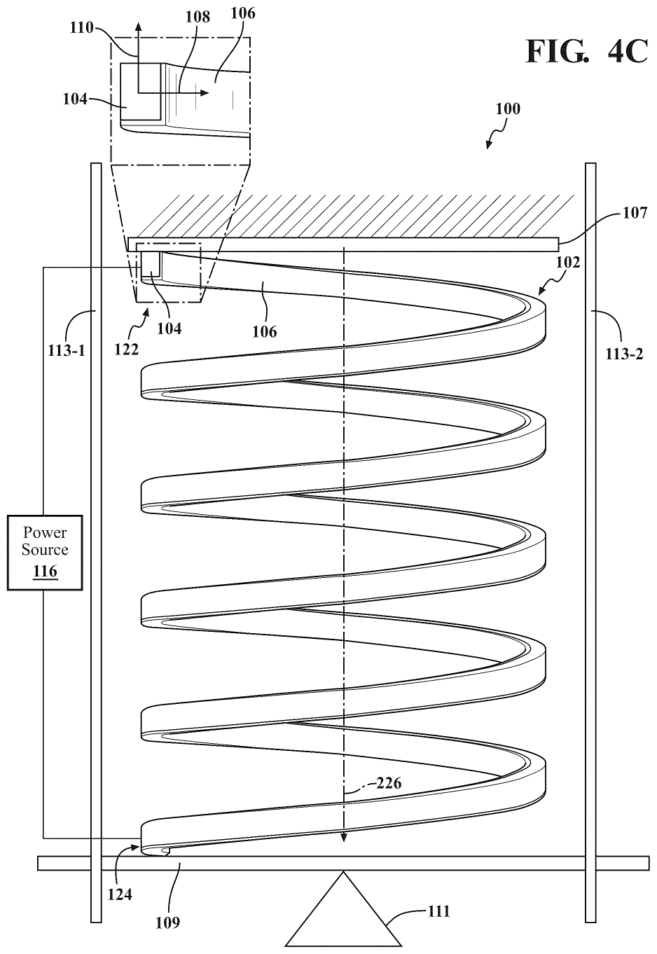

FIGS. 4A-4C illustrate one embodiment of an actuation device 102 that axially extends and axially coils responsive to an activation input, according to an embodiment of the principles described herein. As described above, the surfaces of the first coil strip 104 over which the surfaces of the second coil strip 106 are disposed define the actuation characteristics of the actuation device 102. In the example depicted in FIGS. 4A-4C, the first leg of the second coil strip 106 is disposed on the bottom surface of the first coil strip 104, and a second leg of the second coil strip 106 is disposed on the inside surface of the first coil strip 104. As with the example depicted in FIGS. 1A-1C, the actuation device 102 has an asymmetric cross-section in two orthogonal directions. Specifically, the actuation device 102 is asymmetrical about the x-axis 108 of the cross-section, and the actuation device 102 is asymmetrical about the y-axis 110 of the cross-section. That is to say, the physical structure of the top portion of the actuation device 102 above an x-axis 108 differs from the physical structure of the bottom portion of the actuation device 102 below the x-axis 108. Similarly, the physical structure of an inside portion of the actuation device 102 (i.e., to the right of the y-axis 110) differs from the physical structure of an outside portion of the actuation device 102 (i.e., to the left of the y-axis 110).

This asymmetry about both orthogonal axes 108 and 110 facilitates the linear and torsional deformation. The characteristics of the asymmetry, that is the surfaces of the first coil strip 104 that are overlaid with the second coil strip 106 define the direction of axial deflection/deformation as indicated by the arrow 112 and axial twist as indicated by the arrow 114.

Specifically, as depicted in FIGS. 4A-4C, in a y-axis 110 direction, 1) the second material being disposed on a bottom surface of the first material and 2) the second material having a lower CTE than the first material, causes the actuation device 102 to extend in an axial direction as depicted by the arrow 226 in FIG. 4B. That is, in a bi-material actuation device 102, movement is generally towards the material with the lower CTE in a particular direction. As the lower CTE material (i.e., the second material) is below the higher CTE material (i.e., the first material), the movement of the actuation device 102 in the y-axis 110 direction is generally downwards in the frame of view of FIGS. 4A-4C.

By comparison, in an x-axis 108 direction, 1) the second material being disposed on an inside surface of the first material and 2) the second material having a lower CTE than the first material causes the actuation device 102 to coil further about a longitudinal axis as depicted by the arrow 120 in FIG. 4B. That is, in a bi-material actuation device 102, movement is generally towards the material with the lower CTE in a particular direction. As the lower CTE material (i.e., the second material) is on the inside of the higher CTE material (i.e., the first material), the rotation of the actuation device 102 about the y-axis 110 is generally inwards, i.e., a tighter coiling about the y-axis 110.

As described above, in some examples, the amount of linear deflection can be adjusted by preventing the rotation of the actuation device 102. For example, as depicted in FIG. 4B, a first end 122 of the actuation device 102 may be rigidly attached to a reference surface. That is, the first end 122 may not move (either axially or torsionally) relative to the reference surface. The second end 124, by comparison, may be translationally and rotationally moveable relative to the first end 122. That is, the second end 124 may be a free end. Put yet another way, the second end 124 may translate in the direction indicated by the arrow 226 and may twist in the direction indicated by the arrow 120.

In an example depicted in FIG. 4C, the first end 122 may be rigidly attached to the reference surface 107 and, therefore, does not deflect in an axial or torsional direction relative to the reference surface 107. However, in this example, the second end 124 is linearly moveable but rotationally fixed relative to the first end 122. That is, the first end 122 and the second end 124 are in the same axial position even as the second end 124 may translate axially. For example, a transverse rod 109 may be attached to the second end 124. A weight 111 may be hung from the transverse rod 109. The weight 111, plus an interaction between the transverse rod 109 and a pair of linear guide rails 113-1 and 113-2, prevent the rotation of the second end 124 relative to the first end 122, but that allows the second end 124 to translate downwards as indicated by the arrow 226. The stroke, or translational distance, of the second end 124 may be greater when the second end 124 is prevented from twisting, as depicted in FIG. 4C.

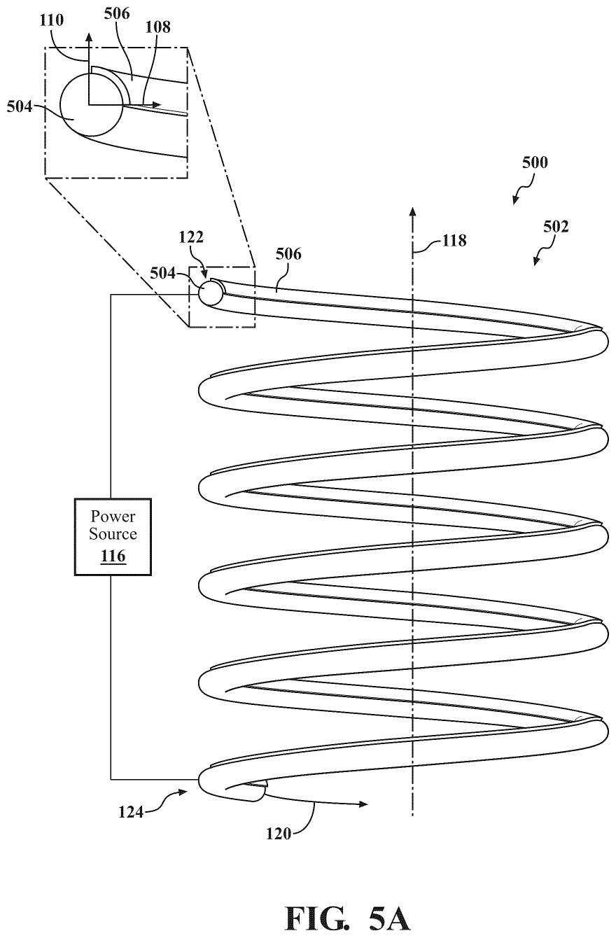

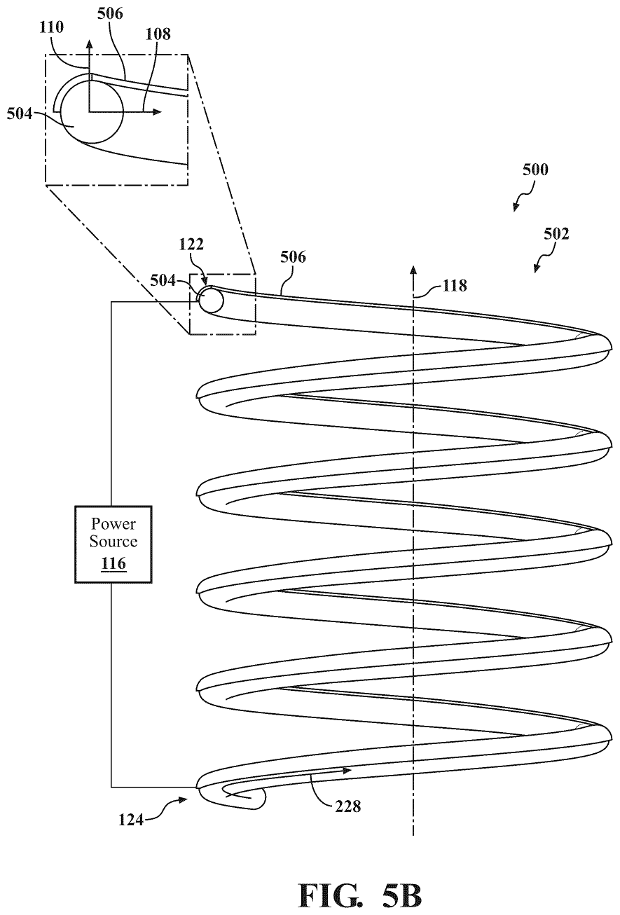

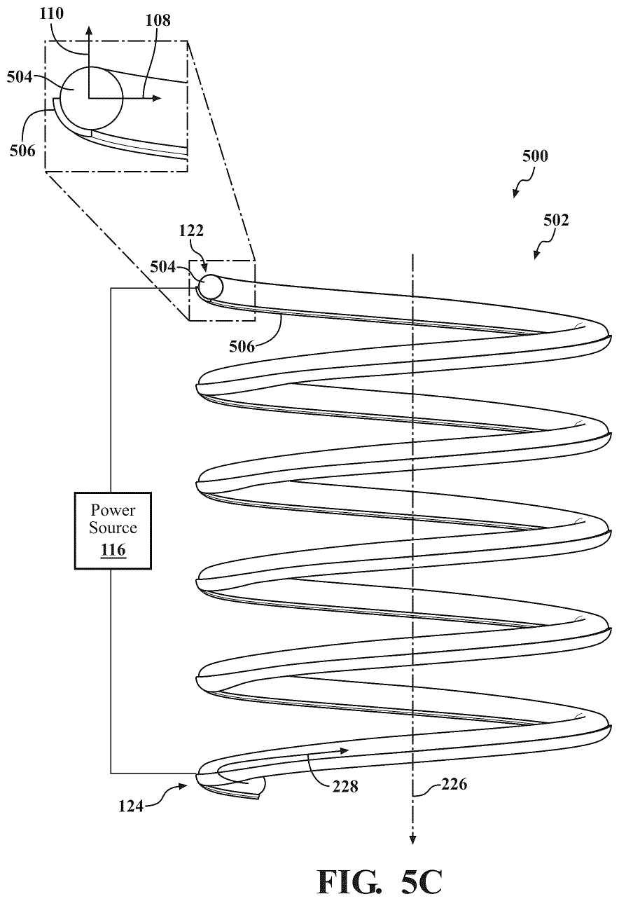

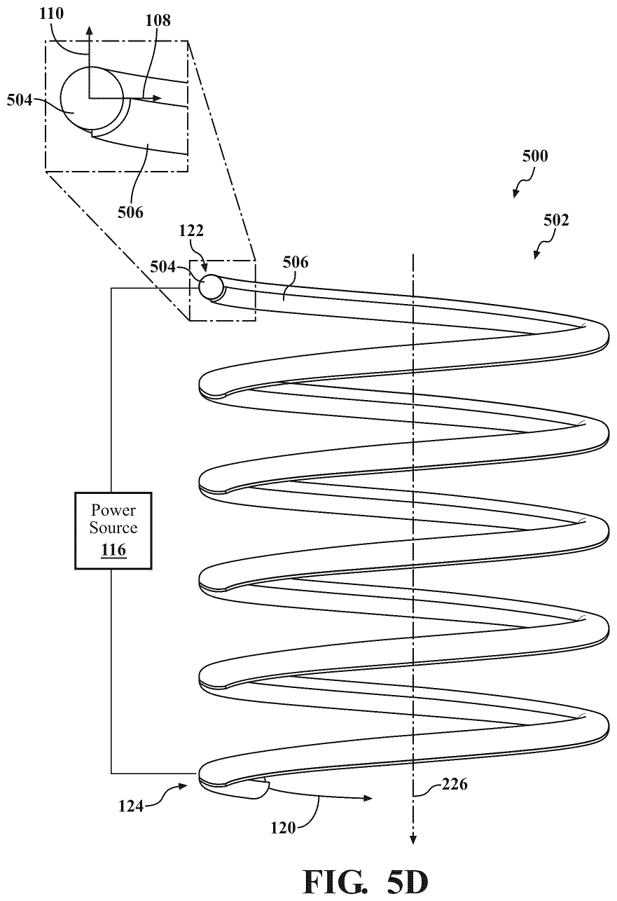

FIGS. 5A-5D illustrate embodiments of an actuation system 500 with an actuation device 502 with a circular cross-sectional shape, according to embodiments of the principles described herein. As described above, the actuation device may have different cross-sectional shapes. In the example depicted in FIGS. 5A-5D, the first coil strip 504 has a circular cross-sectional shape, and the second coil strip 506 has a semi-circular cross-sectional shape and is disposed on one quadrant of the circular cross-sectional shape of the first coil strip 504. Note that in this example, the actuation device 502 still has an asymmetrical cross-section along the x-axis 108 and the y-axis. That is to say, the physical structure of the top portion of the actuation device 102 above an x-axis 108 differs from the physical structure of the bottom portion of the actuation device 102 below the x-axis 108. Similarly, the physical structure of an inside portion of the actuation device 102 (i.e., to the right of the y-axis 110) differs from the physical structure of an outside portion of the actuation device 102 (i.e., to the left of the y-axis 110). While the circular cross-section actuation device 502 may have one axis of symmetry, it does not have two, which facilitates the dual axial/torsional deflection/deformation of the actuation device 502.

As described above, the direction of axial deflection of the actuation device 502 and the direction of axial twist of the actuation device 502 are based on which quadrant of the circular cross-sectional shape of the first coil strip 504 that the second coil strip 506 is joined to.

Specifically, as depicted in FIG. 5A, 1) the second material being disposed on an upper and inside surface of the first material and 2) the second material having a lower CTE than the first material causes the actuation device 102 to contract in an axial direction as depicted by the arrow 118 in FIG. 5A and tighten or coil further about a longitudinal axis, as depicted by the arrow 120 in FIG. 5A. That is, in a bi-material actuation device 102, movement is generally towards the material with the lower CTE in a particular direction. As the lower CTE material (i.e., the second material) is on the top and inside of the higher CTE material (i.e., the first material), the movement of the actuation device 102 may be as depicted by the arrows 118 and 120 in FIG. 5A. As described above, the second end 124 may be fixed rotationally, such that the contraction stroke along the arrow 118 is enhanced as compared to when the second end 124 is free rotationally and translationally relative to the first end 122.

As depicted in FIG. 5B, 1) the second material being disposed on an upper and outside surface of the first material and 2) the second material having a lower CTE than the first material causes the actuation device 102 to contract in an axial direction as depicted by the arrow 118 in FIG. 5A and loosen or uncoil about a longitudinal axis as depicted by the arrow 228 in FIG. 5B. That is, in a bi-material actuation device 102, movement is generally towards the material with the lower CTE in a particular direction. As the lower CTE material (i.e., the second material) is on the top and outside of the higher CTE material (i.e., the first material), the movement of the actuation device 102 may be as depicted by the arrows 118 and 228 in FIG. 5B. As described above, the second end 124 may be fixed rotationally, such that the contraction stroke along the arrow 118 is enhanced as compared to when the second end 124 is free rotationally and translationally relative to the first end 122.

As depicted in FIG. 5C, 1) the second material being disposed on a lower and outside surface of the first material and 2) the second material having a lower CTE than the first material causes the actuation device 102 to extend in an axial direction as depicted by the arrow 226 in FIG. 5C and loosen or uncoil about a longitudinal axis as depicted by the arrow 228 in FIG. 5C. That is, in a bi-material actuation device 102, movement is generally towards the material with the lower CTE in a particular direction. As the lower CTE material (i.e., the second material) is on the bottom and outside of the higher CTE material (i.e., the first material), the movement of the actuation device 102 may be as depicted by the arrows 226 and 228 in FIG. 5C. As described above, the second end 124 may be fixed rotationally, such that the contraction stroke along the arrow 118 is enhanced as compared to when the second end 124 is free rotationally and translationally relative to the first end 122.

As depicted in FIG. 5D, 1) the second material being disposed on a lower and inside surface of the first material and 2) the second material having a lower CTE than the first material causes the actuation device 102 to extend in an axial direction as depicted by the arrow 226 in FIG. 5D and tighten or coil further about a longitudinal axis, as depicted by the arrow 120 in FIG. 5D. That is, in a bi-material actuation device 102, movement is generally towards the material with the lower CTE in a particular direction. As the lower CTE material (i.e., the second material) is on the bottom and inside of the higher CTE material (i.e., the first material), the movement of the actuation device 102 may be as depicted by the arrows 226 and 120 in FIG. 5D. As described above, the second end 124 may be fixed rotationally, such that the contraction stroke along the arrow 118 is enhanced as compared to when the second end 124 is free rotationally and translationally relative to the first end 122.

FIG. 6 illustrates a flowchart for one embodiment of a method 600 that is associated with forming a coil actuator with asymmetric material coil strips. At 610, the method 600 includes forming a first material into a first coil strip 104. The formation of the first coil strip 104 may include various manufacturing operations and may be dictated by the type of material. Examples of operations include molding, extruding, and three-dimensional printing. That is, the first material in liquid form may be injected into a mold or cast and allowed to cure or harden. Once cured or hardened, the material may be removed from the mold. In another example, the first material may be 3D printed using various 3D printing techniques. In another example, the first material in a malleable state may be extruded through an opening to form the first material into a coil/spring shape.

At 620, the method 600 includes forming a second material into a second coil strip 106. As with the formation of the first coil strip 104, the formation of the second coil strip 106 may include various manufacturing operations and may be dictated by the type of material. Examples of operations include molding, extruding, and three-dimensional printing. That is, the second material in liquid form may be injected into a mold or cast and allowed to cure or harden. Once cured or hardened, the material may be removed from the mold. In another example, the second material may be 3D printed using various 3D printing techniques. In another example, the second material in a malleable state may be extruded through an opening to form the second material into a coil/spring shape.

In any case, at 630, the method includes attaching the second coil strip 106 to the first coil strip 104 asymmetrically on an exterior surface of the first coil strip 104. As described above, the attachment may be done in various ways. In one example, an adhesive is deposited between mating surfaces of the first coil strip 104 and the second coil strip 106. In another example, the first coil strip 104 is bonded to the second coil strip 106. For example, the second coil strip 106 may be placed in a mold, and the first material may be poured into the mold in a malleable, liquid, or semi-liquid state. As it cures, the first coil strip 104 may adhere to the second coil strip via acrylate bonding. In any case, via this method 600, an asymmetric bi-material actuation device is formed that exhibits dual-axis displacement, which in the case of a coiled actuator manifests as axial contraction/extension and axial coiling/uncoiling, based on which surfaces of the actuation device include the second material.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An actuation device, comprising:
a first coil strip of a first material; and
a second coil strip of a second material, the second coil strip is joined to and asymmetrically disposed on an exterior surface of the first coil strip, a coefficient of thermal expansion of the second material is different than a coefficient of thermal expansion of the first material.

2. The actuation device of claim 1, wherein the coefficient of thermal expansion of the second material is less than the coefficient of thermal expansion of the first material.

3. The actuation device of claim 1, wherein:
the first coil strip has a quadrilateral cross-sectional shape with four right-angled corners;
the second coil strip has an L-shaped cross-sectional shape and is disposed on two adjacent exterior surfaces of the quadrilateral cross-sectional shape of the first coil strip;
a direction of axial deflection of the actuation device is based on which of a top and bottom surface of the first coil strip a first leg of the second coil strip is joined; and
a direction of axial twist of the actuation device is based on which of an inside and outside surface of the first coil strip a second leg of the second coil strip is joined.

4. The actuation device of claim 1, wherein:
the first coil strip has a circular cross-sectional shape;
the second coil strip has a semi-circular cross-sectional shape and is disposed on at least one quadrant of the circular cross-sectional shape of the first coil strip; and
a direction of axial deflection of the actuation device and a direction of axial twist of the actuation device are based on the quadrant of the circular cross-sectional shape of the first coil strip to which the second coil strip is joined.

5. The actuation device of claim 1, wherein:
a first end of the actuation device is translationally and rotationally fixed to a reference surface; and
a second end of the actuation device is translationally and rotationally moveable relative to the first end.

6. The actuation device of claim 1, wherein:
a first end of the actuation device is translationally and rotationally fixed to a reference surface; and
a second end of the actuation device is translationally moveable and rotationally fixed relative to the first end.

7. The actuation device of claim 1, wherein the first material and the second material are metallic.

8. The actuation device of claim 1, wherein the first material is an epoxy.

9. The actuation device of claim 1, wherein the second material is a nickel-iron alloy.

10. An actuation system, comprising:
an actuation device comprising:
a first coil strip of a first material; and
a second coil strip of a second material, the second coil strip is joined to an exterior surface of the first coil strip, a coefficient of thermal expansion of the second material is different than a coefficient of thermal expansion of the first material and the actuation device has an asymmetric cross-section in two orthogonal directions; and
a power source to apply a shape-changing current across the actuation device.

11. The actuation system of claim 10, wherein the coefficient of thermal expansion of the second material is less than the coefficient of thermal expansion of the first material.

12. The actuation system of claim 10, wherein:
the first coil strip has a quadrilateral cross-sectional shape with four right-angled corners;
the second coil strip has an L-shaped cross-sectional shape and is disposed on two adjacent exterior surfaces of the quadrilateral cross-sectional shape of the first coil strip;
a direction of axial deflection of the actuation device is based on which of a top and bottom surface of the first coil strip a first leg of the second coil strip is joined; and
a direction of axial twist of the actuation device is based on which of an inside and outside surface of the first coil strip a second leg of the second coil strip is joined.

13. The actuation system of claim 10, wherein:
a first end of the actuation device is translationally and rotationally fixed to a reference surface; and
a second end of the actuation device is:
translationally and rotationally moveable relative to the first end; or
translationally moveable and rotationally fixed relative to the first end.

14. The actuation system of claim 10, wherein the first material and the second material are metallic.

15. The actuation system of claim 10, wherein:
the first material is an epoxy; and
the second material is a nickel-iron alloy.

16. A method, comprising:
forming a first material into a first coil strip;
forming a second material into a second coil strip, a coefficient of thermal expansion of the second material is different than a coefficient of thermal expansion of the first material; and
attaching the second coil strip to the first coil strip asymmetrically on an exterior surface of the first coil strip.

17. The method of claim 16, wherein at least one of forming the first material into the first coil strip and forming the second material into the second coil strip comprises molding at least one of the first material and the second material into a respective coil strip shape.

18. The method of claim 16, wherein at least one of forming the first material into the first coil strip and forming the second material into the second coil strip comprises at least one of extruding at least one of the first material and the second material into a respective coil strip shape.

19. The method of claim 16, wherein at least one of forming the first material into the first coil strip and forming the second material into the second coil strip comprises at least one of 3D printing at least one of the first material and the second material into a respective coil strip shape.

20. The method of claim 16, wherein attaching the second coil strip to the first coil strip comprises:
depositing an adhesive between mating surfaces of the second coil strip and the first coil strip; or
bonding the second coil strip to the first coil strip.
